(19) United States
(12) Patent Application Publication
(10) Pub. No.: US 2019/0351652 A1
(43) Pub. Date: Nov. 21, 2019

(54) A LAMINATE MADE OF A MULTILAYER POLYESTER FILM AND OF AN ALUMINIUM SHEET, METHOD FOR MANUFACTURING SAID LAMINATE, AND BEVERAGE CAN ENDS MADE FROM SAID LAMINATE

(71) Applicants: TORAY FILMS EUROPE, SAINT MAURICE DE BEYNOST (FR); NOVELIS INC., Atlanta, GA (US)

(72) Inventors: Hideki FUJII, Mishima-city (JP); Valérie LACRAMPE, Orlienas (FR); Audrey ULRICH SAINT-PIERRE, Lyon (FR); Julien FALDYSTA, Reyrieux (FR); Peter SPAHN, Göttingen (DE); Heinrich PRINZHORN, Göttingen (DE); Nicolas KAMP, Uslar (DE)

(73) Assignees: TORAY FILMS EUROPE, SAINT MAURICE DE BEYNOST (FR); NOVELIS INC., Atlanta, GA (US)

(21) Appl. No.: 16/323,344

(22) PCT Filed: Aug. 5, 2016
(86) PCT No.: PCT/IB2016/001279

§ 371 Date: Feb. 5, 2019

(51) Int. Cl. B32B 15/09; B32B 27/20; B32B 27/08; B32B 15/20; B32B 27/36; C08G 63/183; C08G 63/199

(52) U.S. Cl. CPC B32B 15/09; B32B 27/20; B32B 27/08; B32B 15/20; B32B 2307/702; C08G 63/183; C08G 63/199; B32B 2307/518; B32B 2439/66; B32B 27/36

(57) ABSTRACT

A laminate aluminium/multilayer biaxially oriented polyester film with successively:
M—an aluminum support; C—an amorphous layer C having a copolyester PET-G—which the diol units include Ethylene Glycol EG—units and CycloHexaneDiMethanol CHDM—units;
B—a crystallizable layer B having: a copolyester PET-X which the diol units include Ethylene Glycol EG—units and which the acid units include Terephtalic Acid TA—units and units of at least one Dicarboxylic Acid Different From Terephtalic Acid [DADFTA units], the DADFTA units being chosen in the group consisting of Isophtalic Acid IA—units, Sebacic Acid SA—units, Adipic Acid AA—units, and mixtures thereof; and possibly a polyester PolyEthyleneTerephtalate PET;
A—optionally a layer A, identical or different from the layer B
i. the concentration of the CHDM units in the layer C has between 18 and 34 mol %;
ii. the melting temperature of the layer B is comprised between 180 and 245° C.

### FIELD OF THE INVENTION

This invention relates to laminates comprising an aluminum sheet and multilayer polyester film, in particular aromatic polyester films such as polyethylene terephthalate (PET), polybutylene terephthalate (PBT) or polyethylene naphthalate (PEN), said polyester films having preferably a biaxial orientation.

These laminates are used in packaging applications: manufacture of containers, particularly foods containers like aluminium cans.

The invention relates to the manufacture and the use of laminates aluminium/polyester films to produce beverage can ends.

### DESCRIPTION OF THE TECHNICAL PROBLEM AND PRIOR ART

The colamination of polyester films on aluminium substrates or sheets is an application under development. Polyester film/aluminium sheet laminates are useful in particular as raw material for the packaging industry.

In this application, there is a need for biaxially oriented multilayer transparent polyester film, which can form a solid coating composition for use on the exterior and interior of beverage containers ends that exhibits the advantageous properties of adhesion, flexibility, chemical resistance, and corrosion inhibition, and that is economical and does not adversely affect the taste or other esthetic properties of beverages packaged in the container. The existing organic solvent-based coating compositions complies with these specifications but have the major drawback to be particularly detrimental in respect of the environmental and toxicological aspects, due to the organic solvents and components such as Bis-Phenol A.

U.S. Pat. No. 8,808,844B2 discloses an article comprising: a aluminium sheet, and a biaxially oriented polymeric film heat-bonded to at least one major surface of the aluminium sheet. The polymeric film comprises [EG: ethylene-glycol; TA: terephtalic acid; CHDM: cyclohexane dimethanol]:
1. a first adhesive and amorphous layer adjacent the aluminium sheet comprising one or more polyester materials: e.g. 33 wt % of PET (polyester EG-TA) and 67 wt % of PET-G (copolyester EG-CHDM-TA);
2. a second layer (sometimes called the “core” layer) comprising a majority by weight of one or more crystallizable polyester-based polymers: e.g. 82 wt % of PET (polyester EG-TA), 15 wt % of PET-G (copolyester EG-CHDM-TA), 2.7 wt % of a polyamide and 0.3 wt % of cobalt salt;
3. and third layer (top layer) comprising 67 wt % of PET (polyester EG-TA), 32 wt % of PET-G (copolyester EG-CHDM-TA) and 1 wt % of wax blend.
   The thickness of the first layer is in the range of about 5% to 40% of the overall film thickness, the thickness of the second layer in the range of about 20% to 95% of the overall film thickness, and the thickness of any optional other layers, if present, is up to 40% of the film overall thickness.

Such multilayer polyester films which are intended to form laminated packaging raw materials, are required to have the following properties:
a—low feathering, i.e low (<0.8 mm) or no formation of feathers of multilayer polyester film when the lid of a aluminium/multilayer polyester film can is perforated by means of a tab.
b—high adhesion between aluminum substrate and the multilayer polyester film, even at low lamination temperature with aluminum sheet. That means no delamination between the aluminum sheet and the multi-layered polyester film when a force in any direction is applied to the film.
c—absence or low migration of components from the multilayer polyester film, to the content of the beverage container made of a laminate aluminium/multilayer polyester film. There should be no adsorption of aroma components from the can contents by the film, nor will the flavor of the contents be harmed by materials dissolved out of the film
d—resistance to corrosion, especially acid corrosion.
e—resistance to heat treatment (pasteurization) process to which the filled cans made from said laminate are eventually subjected.
f—high tensile strength of the aluminium substrate e.g. between 355-340 MPa
g—formability:sufficient flexibility to resist to stamping and molding of the laminate aluminium/multilayer polyester film during the manufacture of can ends. No defects such as pin holes or cracks should be produced following fabrication. The polyester film should not separate away, or show cracking or pin holes generation when the aluminium can is subject to impact.

Multilayer polyester films according to U.S. Pat. No. 8,808,844B2 can be improved in particular with regards to these properties a—to g—.

An object of this invention consists in providing such improved multilayer polyester films.

### Objectives of the Invention

In this context, one of the essential objectives of this invention is to provide an improved laminate composed of a sheet of aluminum and of a multilayer polyester film, the improvement pertaining at least one of the following properties:
a—feathering,
b—adhesion aluminium/multilayer polyester film,
c—absence or low migration,
d—resistance to acid corrosion,
e—resistance to heat treatment (pasteurization),
f—retained tensile strength,
g—formability.

Another objective of the invention is to provide a laminate of aluminum/biaxial oriented multi-layered polyester film, having said a—to g—features and making it possible to produce, easily and cheaply, from said laminate, easy-open ends for beverage cans.

Another objective of the invention is to provide a method for obtaining a laminate of aluminum/biaxial oriented multi-layered polyester film, which satisfies the above objectives, said method being simple to implement, cheap and industrial.

Another objective of the invention is to provide easy-open ends for beverage cans made from said laminate.

### BRIEF DESCRIPTION OF THE INVENTION

These objectives are achieved by this invention which relates, in a first aspect to a laminate aluminium/multilayer (biaxially oriented) polyester film comprising successively:
M—an aluminum support;
C—at least one amorphous layer C comprising at least one copolyester PET-G—which the diol units include Ethylene Glycol EG—units and CycloHexaneDiMethanol CHDM—units;
B—at least one polyester layer B comprising:
   at least one copolyester PET-I which the diol units include Ethylene Glycol EG—units and which the acid units include Terephtalic Acid TA—units and Isophtalic Acid IA—units;
      and
   possibly at least one polyester PolyEthyleneTerephtalate PET;
A—at least one layer A, identical or different from the layer B and comprising at least one polyester, preferably at least one polyester PolyEthyleneTerephtalate PET, and possibly at least one copolyester PET-I which the diol units include Ethylene Glycol EG—units and which the acid units include Terephtalic Acid TA—units and Isophtalic Acid IA—units;
wherein
   i the concentration of the CHDM units in the layer C is comprised between 18 and 34 mol %, preferably between 22 and 33 mol %;
   ii the concentration of the IA units in the layer B is greater than or equal to 9 mol %, preferably comprised between 9 and 36 mol %, and more preferably comprised between 11-18 mol %;
   iii at least one of the layers C,B,A, preferably the layer B and/or the layer A, incorporates filler particles which have a median diameter d50 in the following ranges given herein in an increasing order of preference and in μm: [2.0-12.0], [3.0-10], [5.0-9.0].

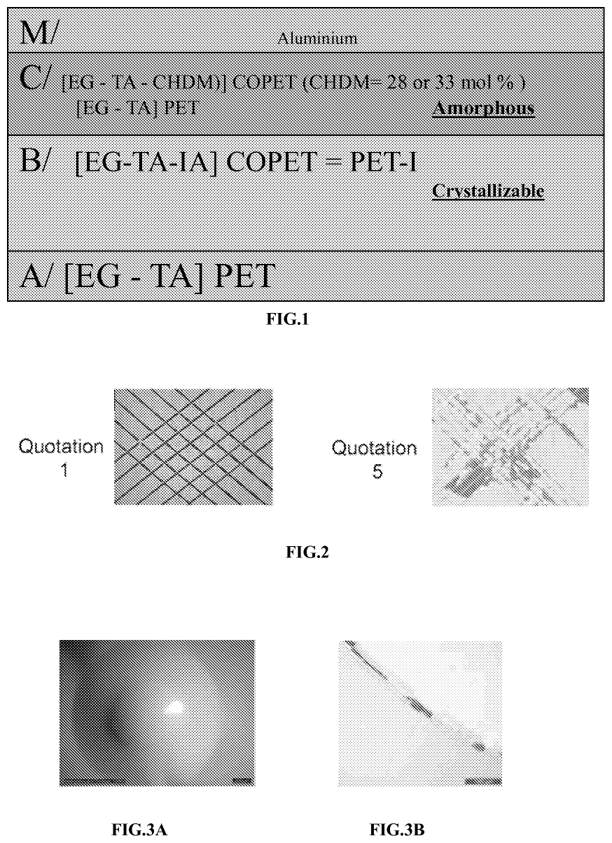

For illustration purpose, the enclosed FIG. 1 is a section scheme of an example of a laminate aluminium/multilayer according to the invention.

It was a surprising discovery that the combination of the features (i)(ii)(iii) is very important to the performance of the film. Said combination provides greater adhesion than comparable polymers when laminating to substrate such as aluminum. This increased bonding strength gives rise to laminate structures that can adequately be applied and bonded to commercially available substrates using commercially available equipment. And the surprising benefit of the combination of the features (i)(ii)(iii) is the resistance to the acid media and non crystallization during post heating (pasteurization). Many coated articles used in the beverage packaging industry undergo a post-heating step such as pasteurization or retort whereby the article is exposed to steam or water in the temperature range of 80−130° C. During this pasteurization, crystallizable polyesters will tend to display some level of crystallization which can lead to cracking, crazing or reduction in adhesion. Any of these defects will reduce the overall quality of the laminate and can cause the article to be rejected by a consumer.

The structure of the laminate and particularly, the combination of the features (i)(ii)(iii) is modified to provide a laminated film having excellent feathering properties. Minimum coating feathering is desired in certain end uses such as, for example, easy-open ends for beverage cans. The production of such can ends typically includes pre-scoring of the aluminium substrate, which subsequently allows for the opening of the can end using a pull tab attached to a rivet of the can end to enable consumption of the packaged beverage product. The use of this scoring technique requires that both the substrate and the applied coating tear easily and cleanly. The absence of clean tearing is often referred to as “feathering” (or hairing) due to the presence of unsuitable amounts of residual coating across the opening of the can. It is generally undesirable for the interior coating to display appreciable feathering, as it can be esthetically unpleasing to consumers of the packaged beverage product. As such it is desirable that coatings used for the interior of easy-open ends for beverage cans do not display appreciable feathering.

According to an advantageous variant, the layer B and/or the layer A comprise(s):
at least one copolyester PBT-X which the diol units include Butylene Glycol BG—units and which the acid units include Terephtalic Acid TA—units and units of at least one Dicarboxylic Acid Different From Terephtalic Acid [DADFTA units], said DADFTA units being preferably chosen in the group consisting of Isophtalic Acid IA—units, Sebacic Acid SA—units, Adipic Acid AA—units, and mixtures thereof; and
possibly at least one polyester PolyButyleneTerephtalate PBT.

In a particular embodiment of the laminate according to the invention, the multilayer polyester film comprises a layer A different from the layer B, and the layer A is crystallizable layer of polyester resin including at least 50% by weight of Poly-Ethylene Terephthalate (PET).

According to a remarkable feature of the invention, at least one of the layers C,B,A, preferably the layer B and/or the layer A, includes fine particles different from the filler particles

Advantageously, the fine particles and the filler particles are chosen among inorganic and/or organic particles, preferably in the group comprising and more preferably consisting in: titanium oxide, barium sulfate, silicon dioxide, aluminum oxide particles, zirconium oxide, tin oxide, calcium carbonate, calcium phosphate, zeolite, hydroxyapatite, aluminum silicate, wet-based and dry-based colloidal silica and alumina, polymer including styrene, silicone, polyacrylic acid, polymethacrylic acid, polyester, polymer including divinyl benzene and mixtures thereof.

As fas as the fine particles are concerned, said fine particles include for instance barium sulfate and/or titanium oxide particles in the following concentration ranges given herein in an increasing order of preference and in % w/w: [1-25]; [2-20]; [3-10].

As fas as the filler particles are concerned, said filler particles preferably include silicon dioxide particles.

It is an outstanding feature of the invention that the intrinsic viscosity (IV) of any layer of the multilayered polyester film of the laminate, is between 0.45 to 0.90 dl/g and, in particular, 0.50 to 0.80.

Advantageously, the C-layer thickness is comprised within the following ranges given herein in an increasing order of preference and in μm: [0.3-6.0]; [0.5-5.0]; [0.7-4.0].

With respect to another mode of expression, the C-layer thickness is preferably comprised within the following ranges given herein in an increasing order of preference and in % of the overall film thickness: [0.5-40]; [0.8-25]; [1.0-20].

The film of the laminate according to the invention can be also described through the following advantageous features:
1st—the total light transmittance, TLT measured on the film is comprised between the following ranges given herein in an increasing order of preference and in %:[<90]; [<80]; [<70]; and/or
2nd—the Haze measured on the film is comprised between following ranges given herein in an increasing order of preference and in %: [>70]; [>80]; [>90].

The film of the laminate according to the invention is preferably characterized by a decrease of the feathering after lamination with aluminium substrates between the following ranges given herein in an increasing order of preference and in mm:
[<0.8]; [<0.7]; [<0.6].

It is particularly important that the aluminum/polyester laminated sheet keeps good mechanical properties vs. unprocessed aluminum. In the case where the lamination temperature and above all the annealing temperature of its manufacture process is too high, the mechanical properties of the laminate, and particularly of the aluminum sheet is damaged. This phenomenon is opposed to the search of adhesion between the multilayer polyester and the Al sheet, which requires enough heating.

So, thanks to the new and inventive structure of the laminate, this latter has advantageously a tensile strength or yield strength at the 0.2% elongation, over 330 Mpa, preferably of at least 340 Mpa.

Thus, the invention also concerns a method for manufacturing a laminate according to the invention, wherein the multilayer biaxially oriented polyester film is laminated with an aluminum sheet, said lamination preferably comprising an a preheating step of the aluminium from 180 to 220° C., a lamination step, an annealing step in the range of 250° C. to 275° C. and cooling step, preferably by air cooling. And the invention encompasses moreover a beverage can end made from the laminate wherein the film is the internal wall of said can end and is in contact with the beverage.

### DETAILED DESCRIPTION OF THE INVENTION

Note that in this text, any “singular” can be interpreted as a “plural” and vice versa.

The laminate according to the invention corresponds to an assemblage of different layers each having their own physical existence. It is obtained by technologies such as pasting, laminating, extrusion coating, complexing, etc.

The multilayer polyester film of the laminate according to the invention is suitable for various applications such as packaging applications for which at least one of the afore mentioned properties a—to g—is required.

### Aluminum Sheet

Usually this Aluminium sheet is a flat blank from very stiff cold-rolled sheet. Such aluminum has a gauge and a surface treatment suitable for the manufacture of beverage cans ends. This sheet is typically alloy 5182-H19, which is aluminum with about 4.5% manganese and 0.3% magnesium to give it strength and formability. The laminated aluminum blank is subjected to a serie of mechanical cold forming processes to produce beverage can ends.

### Multilayer Polyester Film

For example, the multilayer polyester film according to the invention is a three-layer polyester film C/B/A.

The biaxially oriented polyester films which can compose these layers are, for example:
either constituted by polyethylene terephthalate,
or they are mixtures, or not, of polyethylene terephthalate copolyesters containing cyclohexyl dimethylol units instead of the ethylene units (see U.S. Pat. No. 4,041,206 or EP-A-0408042),
or are composed of mixtures, or not, of polyethylene terephthalate copolyesters with a polyester portion having isophthalate units (see patent EP-B-0515096),
or are constituted by several layers of polyesters of different chemical natures, as described previously, obtained by coextrusion.

Specific examples of aromatic polyesters are in particular polyethylene terephthalate (PET), polyethylene isophthalate, polybutylene terephthalate, poly-(dimethyl-1,4-cyclohexyleneterephthalate) and polyethylene-2,6-naphthalene-dicarboxylate. The aromatic polyester can be a copolymer of these polymers or a blend of these polymers with a small quantity of other resins, for example and without being limitative, polybutylene terephthalate (PBT).

Suitable biaxial oriented film may be prepared, for example, by stretching a cast polyester film to 2.5 to 5 times its original length in the longitudinal direction and to 2.5 to 5 times its original width in the transverse direction at a temperature higher than the glass transition temperature but lower than the crystallization temperature, and then, heat-setting the stretched film at a temperature of 180 to 240° C. More particularly, a biaxially oriented polyester film, which has been stretched about 3.3 times its original length in the longitudinal direction and about 3.3 times its original width in the transverse direction and, then, heat-set at a temperature of 180 to 200° C. under tension, is optimum in view of its ability to be laminated to a aluminium sheet and subsequent formability.

First Adhesive/Amorphous Layer C:

The “first layer” of the biaxial oriented film is defined as the layer of the film that is in direct contact with the aluminum substrate. This layer C may be alternatively referred to as the “contact layer”, “bonding layer”, “adhesion layer,” or “adhesive layer.”

PET-G

The copolyester PET-G-comprises, on the one hand, diol units which are Ethylene Glycol EG—units and CycloHexaneDiMethanol CHDM—units, and, on the other hand, acid units which are Terephtalic Acid TA—units.

Layer C includes at least 55% wt of one or several amorphous PET-G copolyesters.

The molar % of CHDM—units is in the range of 18-34 mol %, preferably 22-33 mol %. Such range is optimized regarding sealing and adhesion strength with aluminium. PET-G makes it possible to start the sealing for instance from 120-140 degrees Celsius with better pre-adhesion.

PET

Layer C contains also at least one polyethylene terephthalate homopolymer.
The % by weight of PET-G and PET are respectively, for example, between 60 and 90% wt, and between 40 and 10% wt.
The intrinsic viscosity (IV) of layer C is e.g. between 0.65 and 0.80 dl/g.
The C-layer thickness is e.g. between 0.7-3.0 μm and represents e.g 18 to 30% of the multilayer polyester film thickness.
Layer C can also contain between 0.1 and 5% wt of filler particles which D50 is comprised between 1 and 5 μm.

Second Crystallizable Layer B:

PET-I

The copolyester PET-I-comprises, on the one hand, diol units which are Ethylene Glycol EG—units, and, on the other hand, acid units which are Terephtalic Acid TA—units and isophtalic Acid IA—units.

Layer B includes at least 50% wt of one or several PET-I copolyesters.

The molar % of IA—units is in the range of 9-36 mol %, preferably 11-18 mol %.

PET

Layer B can also contain at least one polyethylene terephthalate homopolymer.
Layer B also contains between 0.01 and 10% wt of coarse filler particles which D50 is comprised between 2.5 and 10 μm, and optionally up to 15% wt of fine particles which D50 is comprised between 0.01 and 5 μm.
The coarse filler particles are notably useful in the enhancing of a non-stick property, in the handling and in the processability of the manufacture of the layer B, of the multi-layered film, and of the laminate.
And additionally, the coarse filler particles have a good impact of the feathering performances of the laminate.
The fine particles have a role to enhance masking property after pasteurization and acid media resistance test, and to obtain also good esthetic properties.
The % by weight of PET-I and PET are respectively, for example, between 80 and 100% wt, and between 20 and 0% wt.
The intrinsic viscosity (IV) of layer B is e.g. between 0.50 and 0.70 dug.
The B-layer thickness is e.g. between 1.0-10.0 μm and represents e.g 50 to 90% of the multilayer polyester film thickness.

Third Layer A:

This layer A is preferably different from layer B and C. But in variant, layer A can be the same as layer B.

Polyester PET

The preferred polyester of said layer is a polyethylene terephthalate homopolymer

Copolyester PET-I

Layer A can also contain at least one copolyester PET-I—which comprises, on the one hand, diol units which are Ethylene Glycol EG—units, and, on the other hand, acid units which are Terephtalic Acid TA—units and isophtalic Acid IA—units.

Layer A includes at least 50% wt of one or several PET-I copolyesters.

The molar % of IA—units is in the range of 9-36 mol %, preferably 11-18 mol %.

Layer A also contains between 1 and 15% wt of coarse filler particles which D50 is comprised between 2.5 and 10 μm, and optionally up to 15% wt of fine particles which D50 is comprised between 0.01 and 5 μm.
The % by weight of PET-I and PET are respectively, for example, between 80 and 100% wt, and between 20 and 0% wt.
The intrinsic viscosity (IV) of layer A is e.g. between 0.50 and 0.70 dl/g.
The A-layer thickness is e.g. between 0.5-5.0 μm and represents e.g 5 to 20% of the multilayer polyester film thickness.

Additives

Moreover, if necessary, the polyester film can further contain at least one other additive, preferably selected from the following group: radical scavenger, flame retardant, dye, antistatic agent, antioxidant, organic lubricant, an anti-UV additive or fireproofing additive, a catalyst or any other similar additive.

The anti-UV additive can be selected from several examples of known products such as those described in the work “Additives for plastics on book, John Murphy, 2^{nd} Edition 2001, Elsevier Advanced Technology”. As examples of anti-UV additives, there may be mentioned those of the family of antioxidants or absorbers such as the benzophenones, the benzotriazoles, the benzoxazinones and the triazines; and those of the family of “Hindered amine light stabilizers” (HALS), alone or in combination with antioxidants. These anti-UV additives serve for countering the effects of UV and oxygen on polyester films.

Surface Treatment

The laminate of the invention can have a surface treatment on at least one side, in order to improve adhesion, antistatic performance, slip and winding performance. The surface treatment can be a physical surface treatment (for example UV, corona treatment under ambient air or in the presence of gases, vacuum evaporation, plasma treatment or plasma-assisted vapour phase chemical deposit), or a chemical surface treatment (for example coating of acrylic, copolyester, polyester or polyurethane based formulations).

The chemical surface treatment can be obtained by coextrusion, extrusion coating, in-line coating done prior to transverse stretching during the film making process or off-line coating.

Manufacture of the Multilayer Polyester Film

Multi-layer, biaxially oriented films are preferably prepared in a two-stage process. In a typical commercial process these stages are conducted in tandem and are usually performed in a continuous manner. For the sake of clarity, multi-layered films comprised of three layers will be discussed in more detail, though the principles may be utilized to manufacture multi-layer films having 4, 5, or more layers.

The two stages of the film formation process include (1) the production of a multi-layer cast film and (2) subsequently stretching the cast film according to the processes and ratios previously discussed. This is usually accomplished by heating the multi-layer cast film to an appropriate temperature, and then biaxially stretching the film to achieve the desired film length, width and thickness.
For example, if a three-layer cast film were to be comprised of three different materials (one for each distinct layer) it would be typical to use three extruders, i.e., a dedicated extruder for the feeding of each differing material. A multi-layer die, which is capable of receiving and casting the different materials as a multi-layered molten veil, would be utilized. The thicknesses of the various layers of the veil may be controlled by the rate at which each molten material is fed from the extruder to the die. For example if the melt feed rate of the middle layer extruder is twice that of both of the other extruders one would prepare a film whose layer proportions are, for instance, approximately 12%/67%/21%. The overall thickness of the cast film may be controlled by the overall line speed at which the film is being pulled in conjunction with the total feed rate of molten polymer.
Most materials used for extrusion and film formation are supplied and/or produced in pellet or granulate form. These pellets are typically a few millimeters in length. Each of the materials is metered through the back end of the extruder via a hopper. A gravimetric hopper metering system may be used to control the weight/time feed rates of materials. In typical cast film formation, each hopper of each extruder is fed with only one granulates. Therefore a typical three-layer cast film, which uses a different material for each layer, would typically be made from a total of three different pellets. However, as discussed herein, there are situations where a layer is itself comprised of a blend of more than one material. In such situations, there are at least two practical means of achieving the blend.
The first method would be to simply prepare a blend of the materials (i.e., a simple physical blend of the materials to be mixed) and feeding this cold blend directly to the extruder. When using this approach, one is relying on the extruder to adequately mix and homogenize the cold blend and feed the mixture uniformly to the feeding block of the film die. This method requires an extruder that is able to both meter the materials to the film and uniformly mix the cold blend. Care should be taken when using this approach as many commercial film extruders are not particularly suited for mixing cold blends and usually results in films with very poor homogeneity. A more preferred means of preparing a layer comprised of a blend of more than one material is through “compounding.” In this process, the material used in the layer are again cold blended at the appropriate ratio and are fed into the hopper of an extruder used for material mixing, blending or compounding.
These machines can contain a variety of screw configurations that are designed to achieve material mixing and dispersion. Suitable mixing extruders can be either single- or twin-screw extruders, and can also provide an effective mixing of components while minimizing any overworking of the mixture, which could result in degradation. Once the material blend is passed through the compounding extruder, a single, fully mixed pellet is obtained. This single pellet can then be used in the film production, as no further mixing within the film making extruder is required.
The biaxially-oriented polyester film for fabrication of the present invention can be favorably employed for fabrication processes, for example it is ideal for package applications by lamination to aluminum sheet, and then processing. In particular, it can be favorably used as film for laminating to aluminum sheet and fabricating easy-open ends for beverage cans.
Below, practical examples of the present invention are described but these examples are not to restrict the interpretation of the invention in any way.

### EXAMPLES

### I—Measurements

### Intrinsic Viscosity of the (Co)Polyesters

A sample solution is obtained by dissolution of a given quantity of the sample (polymer or film) at least at 120° C. for 30 min in 100 mL of a solvent mixture of 1,2-dichlorobenzene/phenol 50/50. After cooling down, the elution time of the sample solution is measured with an Ubbelohde viscosimeter. The intrinsic viscosity value IV of the sample is calculated according to the standard ISO 1628/5 using the following correlations.
The viscosity of the pure solvent mixture η0 is compared to the viscosity of the sample solution η.
The relative viscosity ηr is given by:

ηr=η/η0=t*ρ/t0*ρ0

with:
t0 and ρ0 are the elution time and density of the solvent mixture;
t and ρ are the elution time and density of the sample solution.
Since ρ˜ρ0 in our case of study, the following equation for specific viscosity ηsp is therefore obtained: η sp=ηr−1=(t−t0)/t0.
The correlation between lisp and intrinsic viscosity IV is given by:

(ηsp/C)=IV+k*IV²*C

with:
(η sp/C): viscosity number.
C: concentration of polymer in the solution;
K: constant.
The intrinsic viscosity IV can be determined experimentally by measuring the viscosity number (η sp/C) as function of concentration C. The intrinsic viscosity IV corresponds to the value of (η sp/C) when the concentration approaches zero (infinite dilution).

### Median Diameter of Particles d₅₀

The median diameter of particles d₅₀ (expressed in μm) was measured with a laser on a masterSizer from Malvern using a standard method. For the tests, the specimens are placed in a cell with phosphated water (1 g/l of Na₂P₂O₇-10H₂O). The cell is then placed in the test device. The test procedure is automatic and includes the mathematical determination of the value d₅₀. The d₅₀ is determined by the cumulative distribution curve of the size of the particles. The point of intersection of the ordinate 50% with the distribution curve directly gives the value d₅₀ on the axis of the abscissa.

Melting temperature (Tm)
The melting point was measured using a differential scanning calorimeter DSC2 (made by Perkin Elmer). 10 mg of sample was melted and held for 5 minutes at 280 DEG C. under a current of nitrogen, and then rapidly cooled using liquid nitrogen. The sample obtained was heated at a rate of 10 DEG C./minute and the endotherm peak temperature due to crystal melting was taken as the melting point (Tm).

### Polyester Unit (CHDM, IA, EG) Mol % Evaluation

The sample polyester was dissolved in a deuteration solvent (such as CF3 COOD) capable of dissolving the sample and its chemical shift was determined by 1H-NMR, from which the respective ester unit species and their ratios were calculated.
In order to evaluate the polyester unit of each layer, the layers other than the one to be evaluated were removed by plasma treatment, isolating the desired layer.

### Particles Concentration

A sheet was used as a sample, and the content of particle element being characteristic of each particle was calculated with fluorescent-X-ray elemental analysis apparatus (MESA-500W type, manufactured by HORIBA, Ltd.). For example, the titanium dioxide content was converted from the amount of titanium element.

### Layer Thickness

The whole thickness was measured in accordance with thickness gauge and pretreatment was carried out to cut the cross section of the co-extruded layer in a thickness direction with a microtome.Thereafter, the thickness cross section was image-captured at a magnification (×1000) that could take an overview image of the thickness cross section with a field emission scanning electron microscope (FE-SEM)S-800, manufactured by Hitachi, Ltd. and the thickness of the cross section photograph was measured. B Layer or A layer containing pigment or particles can be image-captured as a white layer.
Optical properties [Haze, TLT](%)
Haze and TLT was measured haze meter based on ASTM D 1003.

### Aluminum Yield Strength.

Mechanical properties of the laminate of the examples and of the comparative examples is assessed through the following tensile strength test based on ASTM B 557 for Rp 0.2 in MPa.
Target value is >330 MPa.
Feathering Evaluation [mm]

Feathering means that residual film across the opening of the can is present. This is an optical defect and can raise the concern that the film can fall into the beverage. The feathering should stay far below a value of 0.8 mm of free film over the aluminium edge. This specific value is related to an easy-to-see amount with bare eyes.

Feathering test is described as follows. To test feathering, a “film laminated specimens (10 cm*21 cm)” are cut from three desired location from the laminated coil. Specimens are tested before and after pasteurization. In the case where the measurement is done after pasteurization, the test piece is immersed in a deionized water bath for 40 minutes at 80° C.

The samples are allowed to cool down after pasteurization and the specimen is cut at two different locations in Machine Direction (MD) and Transverse Direction (TD) from the opposite side of film laminated side. And wound up with a pair of pliers from the opposite side of film laminated side. After wounding the laminated sheet, any film that extends from the edge on the test panel is measured. The distance of the greatest penetration (feathering) is reported in mm. Film laminations for easy-open ends for beverage cans preferably show feathering less than or equal to 0.8 mm, preferably less than or equal 0.7 mm, most preferably less than or equal 0.6 mm Certain preferred films of the invention, exhibited a feathering of 0.2-0.6 mm when tested as described above.

Acetic Acid Evaluation

Prepare a 3 vol % of acetic acid solution in water in advance.
Acetic acid evaluation is held as follows: The test piece of the laminate Al/multilayer polyester is marked with a 3 mm distance crosscut, is immersed in 3 vol % acetic acid bath for 30 minutes at 100° C. Then, the aspect of laminated sheet is checked, and a strip of Tesa 4104 sticky tape approximately 50-60 mm long is affixed firmly with the finger across the crosshatch. The tape is then removed from the test panel with a quick snatching motion and examined for any sign of delamination. Any delamination is a failure.

The adhesion level is checked by using TESA tape 4104. And quotations from 1 (good) to 5 (bad) after tear-off are given. Reference is made to the enclosed FIG. 2 for the quotations 1 and 5.

Citric Acid Retort Evaluation

Prepare a 2 wt % of citric acid solution in advance.
Citric acid retort evaluation is held as follows. The test piece of the laminate Al/multilayer polyester to be assessed, is immersed in 2 wt % Citric acid bath for 30 minutes at 121° C. by using a pressure cooker. Then, the aspect of laminated sheet is checked, and a strip of Tesa 4104 sticky tape approximately 50-60 mm long is affixed firmly with the finger across the crosshatch. The tape is then removed from the test panel with a quick snatching motion and examined for any sign of delamination. Any delamination is a failure.

The adhesion level is checked by using TESA tape 4104. And quotations from 1 (good) to 5 (bad) after tear-off are given. Reference is made to the enclosed FIG. 2 for the quotations 1 and 5.

Formability Test: Microscopy: Cracks

To check the ability of the laminates to sustain the deformation to simulate can deformation process. To make reverse impact test based on ASTM D2794, specimen is observed deformed specimen under microscopy to check if it's happened cracks on the film or not.

Reference is made to the enclosed FIGS. 3A & 3B.

### FIG. 3A: Formability: OK.

FIG. 3B: Formability (magnified view at the boarder between the deformed region and the non deformed region): Not Good.

### II—Examples 1-13 According to the Invention/Comparative Examples Comp-1-13

The manufacturing of the multi-layered biaxially oriented polyester film is described hereinafter for the examples 1-13 and the comparative examples comp-1-13.
Said manufacturing is carried out according to the usual conditions for preparation of such films in the field of packaging.
Once the the multi-layered polyester film is produced, said film is laminated, as follows: The film is laminated at speeds up to several hundred meters a minute to an Aluminum sheet (thickness around 0.2 mm) heated to a lamination temperature T1 (° C.). The laminate undergoing adhesion is heated to an annealing temperature T2 (° C.) the above film melting temperature Tm. Then, a rapid cooling is carried out with a cooling to a target temperature lower than 50° C.

### Example 1

### Layer A

Chips of polyester A are made of polyethylene terephthalate (intrinsic viscosity 0.65, Silica concentration 3 wt % & D50; 5.2 micron). Said PET is obtained by heat treating an ethylene glycol slurry containing flocculated silica particles for 2 hours at 190° C. and adding the slurry following the end of the esterification reaction, and then carrying out the polycondensation reaction. After measuring out a specific quantity of these chips, it was dried under vacuum for 3 hours at 180° C. and supplied to a single screw extruder.

### Layer B

Chips of polyester B are made of polyethylene isophthalate 12 mol % (intrinsic viscosity 0.65, Silica concentration 0.05 wt % & D50 5.2 micron). Said PET-I is obtained by heat treating an ethylene glycol slurry containing flocculated silica particles for 2 hours at 190° C. and adding the slurry following the end of the esterification reaction, and then carrying out the polycondensation reaction. After measuring out a specific quantity of this chip, it was supplied to a twin screw extruder without drying.

### Layer C

Chips of PET-G are chips of PET-G EASTAR® 6763 which is co-polyester resin supplied by the Eastman Chemical Company. This resin contains 33-mole % CHDM and 67-mole % ethylene glycol (“EG”), based on the total moles of the diol blend. These chips of PET-G EASTAR® 6763 are then diluted down to 28 mol % by PET.
Chips A & B are dried under vacuum for 3 hours at 180° C. and supplied to a each single screw extruder I & II, Chips C are dried under vacuum for 72 hours at 65° C. and supplied to a single screw extruder III.
The films obtained from these chips are discharged from a normal die and cooled and solidified on a mirror-surface cooled drum while performing electrostatic pinning (7 kv). An undrawn film containing PET-G (drum rotation rate 40 m/min) is produced. This undrawn film is drawn by a factor of 3.2 in the lengthwise direction at a temperature of 105° C. and then cooled to 40° C. After that, the film is pre-heated for 5 seconds at a temperature of 115° C. and then drawn by a factor of 3.6 in the widthwise direction at the same temperature, following which there is a 5 seconds 5% relaxation heat treatment at 190° C., and the biaxially-oriented polyester film of thickness 12 μm of the example 1, is produced.
After lamination with an aluminum sheet, the so got laminate is shown in Table 1, along with its advantageous properties.

### Examples 2 to 9

From extruder I (layer A), extruder II (layer B) and extruder III (layer C) and using the polyesters shown in Table 1, laminated biaxially-oriented polyester film of properties as shown in Table 1 is obtained by melting each polyester and superimposing these just in front of the die, and by varying the drawing conditions in Example 1. As shown in Table 1, the outstanding properties of the laminates according to the invention are confirmed.

### Examples 10 and 11

From extruder I (layer A), extruder II (layer B) and extruder III (layer C) and using the polyesters shown in Table 1, Layer A & Layer B have the same polymer component, laminated biaxially-oriented polyester film of properties as shown in Table 1 was obtained by melting each polyesters and superimposing these just in front of the die, and by varying the drawing conditions in Example 1. As shown in Table 1, the outstanding properties of the laminates according to the invention are confirmed.

### Examples 12 and 13

Biaxially-oriented polyester films are obtained in the same way as in Example 1 by adding the PBT, PBT/I compositions and the drawing conditions in accordance with Table 1. As shown in Table 1, the outstanding properties of the laminates according to the invention are confirmed.

### Comparative Examples 1 to 13

Films are obtained by carrying out film production in the same way as in Example 1 with the several types of polyester and the particles changed to those shown in Table 2. Table 1 and Table 2 are clearly different. The laminates of comparative examples 1 to 13 have less good properties than laminates according to examples 1-13, especially aluminum yield strength, feathering performance and adhesion with aluminum plate.
In addition to that, comparative examples 9, 10 and 13 can't be laminated with aluminum on conditions up to 240° C. So, evaluation results of laminated Al sheets couldn't have been obtained.

| | | | Example | | | | | | | | | | | | |
|---|---|---|---|---|---|---|---|---|---|---|---|---|---|---|---|
| | Items | | 1 | 2 | 3 | 4 | 5 | 6 | 7 | 8 | 9 | 10 | 11 | 12 | 13 |
| Polyester layer A | Formulation | | PET | PET | PET | PET | PET | PET | PET | PET | PET | Same as | Same as | PET | PET |
| | Polymer component | | EG | EG | EG | EG | EG | EG | EG | EG | EG | Layer B | Layer B | EG | EG |
| | Co-polymer [mol %] | | — | — | — | — | — | — | — | — | 17 | | | — | — |
| | IV | | 0.65 | 0.65 | 0.65 | 0.65 | 0.65 | 0.65 | 0.65 | 0.65 | 0.65 | | | 0.65 | 0.65 |
| | Particles. | kinds | Silica | Silica | Silica | Silica | Silica | Silica | Silica | Silica | Silica | | | Silica | Silica |
| | | D50 | 5.2 | 5.5 | 6.2 | 6.5 | 6.1 | 7 | 7.5 | 8.5 | 9 | | | 7.9 | 7.9 |
| | | Concentration (%) | 3 | 3 | 3 | 3 | 3 | 3 | 3 | 3 | 3 | | | 3 | 3 |
| | Melting temperature [° C.] | | 255 | 255 | 255 | 255 | 255 | 255 | 255 | 255 | 255 | | | 255 | 255 |
| | Thickness (um) | | 1.5 | 1.5 | 1.5 | 1.5 | 1.5 | 1.5 | 1.5 | 1.5 | 1.5 | | | 1.5 | 1.5 |
| | Ratio A layer/Total thickness (%) | | 12.5 | 15 | 15 | 12.5 | 12.5 | 12.5 | 12.5 | 12.5 | 12.5 | | | 12.5 | 12.5 |
| Polyester layer B | Formulation | | PET/I | PET/I | PET/I | PET/I | PET/I | PET/I | PET/I | PET/I | PET/I | PET/I | PET/I | PET/I | PET/I |
| | Polymer component | | IPA | IPA | IPA | IPA | IPA | IPA | IPA | IPA | IPA | IPA | IPA | IPA | IPA |
| | Co-polymer [mol %] | | 12 | 12 | 17 | 17 | 12 | 12 | 12 | 15 | 15 | 12 | 17.5 | 15 | 15 |
| | IV | | 0.65 | 0.65 | 0.65 | 0.65 | 0.65 | 0.65 | 0.65 | 0.65 | 0.65 | 0.65 | 0.65 | 0.65 | 0.65 |
| | Particles.1 | kinds | Silica | Silica | Silica | Silica | Silica | Silica | Silica | Silica | Silica | Silica | Silica | Silica | Silica |
| | | D50 | 5.2 | 5.5 | 6.2 | 6.5 | 3 | 3.2 | 6.5 | 8.5 | 3.5 | 2.5 | 3.5 | 3.5 | 3.5 |
| | | Concentration (%) | 0.05 | 0.05 | 0.05 | 0.05 | 2.11 | 2.11 | 0.05 | 0.15 | 2.64 | 0.05 | 6 | 0.05 | 0.05 |
| | Particles 2 | kinds | TiO2 | TiO2 | TiO2 | TiO2 | — | — | TiO2 | TiO2 | — | BaSO4 | BaSO4 | TiO2 | TiO2 |
| | | D50 | 0.3 | 0.3 | 0.3 | 0.3 | — | — | 0.3 | 0.3 | — | 0.7 | 0.7 | 0.3 | 0.3 |
| | | Concentration (%) | 6 | 6 | 6 | 6 | — | — | 4 | 12 | — | 3 | 3 | 6 | 6 |
| | Additional material | | — | — | — | — | — | — | — | — | — | — | — | PBT(50 | PBT/I(25 |
| | | | | | | | | | | | | | | wt %) | wt %) |
| | Melting temperature [° C.] | | 241 | 241 | 233 | 234 | 244 | 241 | 241 | 233 | 237 | 244 | 210 | 219/225 | 219/225 |
| | Thickness (um) | | 8 | 6 | 6 | 8 | 8 | 8 | 8 | 8 | 8 | 8 | 8 | 8 | 8 |
| | Ratio B layer/Total thickness (%) | | 66.7 | 60 | 60 | 66.7 | 66.7 | 66.7 | 66.7 | 66.7 | 66.7 | 66.7 | 66.7 | 66.7 | 66.7 |
| Polyester layer C | Formulation | | PET/G | PET/G | PET/G | PET/G | PET/G | PET/G | PET/G | PET/G | PET/G | PET/G | PET/G | PET/G | PET/G |
| | Polymer component | | CHDM | CHDM | CHDM | CHDM | CHDM | CHDM | CHDM | CHDM | CHDM | CHDM | CHDM | CHDM | CHDM |
| | Co-polymer [mol %] | | 28 | 28 | 28 | 28 | 28 | 28 | 28 | 28 | 18 | 28 | 28 | 33 | 33 |
| | IV | | 0.75 | 0.75 | 0.75 | 0.75 | 0.75 | 0.75 | 0.75 | 0.75 | 0.69 | 0.75 | 0.75 | 0.78 | 0.78 |
| | Particles | kinds | — | — | — | — | — | Silica | — | — | — | — | — | — | — |
| | | D50 | — | — | — | — | — | 3.2 | — | — | — | — | — | — | — |
| | | Concentration (%) | — | — | — | — | — | 0.99 | — | — | — | — | — | — | — |

| | | | | | | | | | | | | | | |
|---|---|---|---|---|---|---|---|---|---|---|---|---|---|---|
| | Additional material(mol %) | — | — | — | — | — | — | IPA(4.5 | — | IPA(14 | — | — | — | — |
| | | | | | | | | mol %) | | mol %) | | | | |
| | Melting temperature [° C.] | — | — | — | — | — | — | — | — | — | — | — | — | — |
| | Thickness (um) | 2.5 | 2.5 | 2.5 | 2.5 | 2.5 | 2.5 | 2.5 | 2.5 | 2.5 | 2.5 | 2.5 | 2.5 | 2.5 |
| | Ratio C layer/Total thickness (%) | 20.8 | 25 | 25 | 20.8 | 20.8 | 20.8 | 20.8 | 20.8 | 20.8 | 20.8 | 20.8 | 20.8 | 20.8 |
| Film | Total thickness (um) | 12 | 10 | 10 | 12 | 12 | 12 | 12 | 12 | 12 | 12 | 12 | 12 | 12 |
| | IV | 0.59 | 0.6 | 0.61 | 0.55 | 0.61 | 0.57 | 0.57 | 0.62 | 0.64 | 0.61 | 0.61 | 0.64 | 0.64 |
| | TLT(%) | 68.4 | 71.8 | 70.7 | 68 | 85.6 | 86.7 | 78.3 | 58.6 | 85 | 71 | 69.5 | 67.9 | 69.5 |
| | Haze(%) | 71.8 | 83.8 | 86.1 | 90.9 | 69.3 | 67.8 | 58.9 | 99.5 | 75.4 | 84.5 | 85.2 | 91.4 | 92.1 |
| Al Lamination | Lamination Temperature - T1 ° C. | 200 | 200 | 220 | 220 | 200 | 220 | 220 | 200 | 200 | 200 | 220 | 200 | 200 |
| result | Annealing temp T2 ° C. | 265 | 265 | 257 | 257 | 265 | 250 | 250 | 265 | 265 | 265 | 257 | 265 | 265 |
| | Alum. Rp 0.2 [Mpa} | 340 | 342 | 343 | 341 | 345 | 346 | 347 | 340 | 347 | 342 | 341 | 340 | 340 |
| | Before pasteurization at 80° C. for 40 min-max. feathering | 0.2 | 0.6 | 0.2 | 0.4 | 0.3 | 0.4 | 0.4 | 0.3 | 0.3 | 0.2 | 0.3 | 0.6 | 0.6 |
| | [mm] | | | | | | | | | | | | | |
| | Before Pasteurization - Cross cut adhesion | 1 | 1 | 1 | 1 | 1 | 1 | 1 | 1 | 1 | 1 | 1 | 1 | 1 |
| | After pasteurization at 80° C. for 40 min-max feathering | 0.2 | 0.3 | 0.2 | 0.3 | 0 | 0.1 | 0.2 | 0 | 0 | 0.2 | 0.3 | 0.2 | 0.2 |
| | [mm] | | | | | | | | | | | | | |
| | After Pasteurization - Cross cut adhesion2 | 1 | 1 | 1 | 1 | 1 | 1 | 1 | 1 | 1 | 1 | 1 | 1 | 1 |
| | After Pasteurization - Blushing | 10 | 10 | 10 | 10 | 7 | 8 | 10 | 9 | 7 | 10 | 10 | 9 | 9 |
| | Cross cut after 3% acetic acid 30 min 100° C. | 1 | 1 | 1 | 1 | 1 | 1 | 1 | 1 | 1 | 1 | 1 | 1 | 1 |
| | Cross cut before 3% acetic acid 30 min 100° C. | No | No | No | No | No | No | No | No | No | No | No | No | No |
| | | delami | delami. | delami. | delami. | delami. | delami. | delami. | delami. | delami. | delami | delami. | delami. | delami. |
| | Blushing after 3% acetic acid 30 min 100° C. - Blush | 9 | 9 | 9 | 9 | 4 | 4 | 9 | 10 | 4 | 8 | 8 | 10 | 10 |
| | Cross cut after Citric acid retort 30 min 121° C. | 1 | 1 | 1 | 3 | 1 | 3 | 1 | 1 | 1 | 1 | 3 | 1 | 1 |
| | Cross cut before Citric acid retort 30 min 121° C. | No | No | No | No | No | No | No | No | No | No | No | No | No |
| | | delami | delami. | delami. | delami. | delami. | delami. | delami. | delami. | delami. | delami | delami. | delami. | delami. |
| | Blushing after Citric acid retort 30 min 121° C. | 10 | 9 | 10 | 10 | 5 | 5 | 10 | 9 | 5 | 8 | 8 | 9 | 9 |
| | Tensile Test: Microscopy: cracks in the film | OK | OK | OK | OK | OK | OK | OK | — | | OK | OK | — | — |

| | | | Comparison | | | | | | | | | | | | |
|---|---|---|---|---|---|---|---|---|---|---|---|---|---|---|---|
| | Items | | 1 | 2 | 3 | 4 | 5 | 6 | 7 | 8 | 9 | 10 | 11 | 12 | 13 |
| Polyester layer A | Formulation | | PET/I | PET | PET | PET/G + | PET | PET | PET | PET | PET/I | PET/I | PET/I | PET/I | PET/I |
| | | | | | | WAX blend | | | | | | | | | |
| | Polymer component | | IPA | EG | EG | CHDM | EG | EG | EG | EG | IPA | IPA | IPA | IPA | IPA |
| | Co-polymer [mol %] | | 17 | — | — | 10.6 | — | — | — | — | 8.5 | 8.5 | 8.5 | 8.5 | 8.5 |
| | IV | | 0.65 | 0.65 | 0.65 | 0.68 | 0.65 | 0.65 | 0.65 | 0.65 | 0.65 | 0.65 | 0.65 | 0.65 | 0.65 |
| | Particles. | kinds | Silica | Silica | Silica | Silica | Silica | Silica | Silica | Silica | Silica | Silica | Silica | Silica | Silica |
| | | D50 | 3.5 | 1.9 | 3.5 | 3.5 | 2.5 | 2.5 | 2.5 | 2.5 | 3.5 | 3.5 | 3.5 | 3.5 | 3.5 |
| | | Concentration (%) | 0.05 | 0.2 | 0.66 | 0.05 | 0.2 | 0.2 | 0.2 | 0.2 | 3 | 3 | 3 | 3 | 3 |
| | Melting temperature [° C.] | | 210 | 255 | 252 | 245 | 252 | 252 | 252 | 252 | 248 | 248 | 248 | 248 | 248 |
| | Thickness (um) | | 1.5 | 2 | 1.5 | 2.4 | 1.5 | 1.5 | 1.5 | 1.5 | 1.7 | 1.7 | 1.7 | 1.7 | 1.7 |
| | Ratio A layer/Total thickness (%) | | 12.5 | 16.7 | 12.5 | 20 | 12.5 | 12.5 | 12.5 | 12.5 | 10 | 10 | 10 | 10 | 10 |
| Polyester layer B | Formulation | | PET/I | PET/I | PET | PET/G | PET/I | PET/I | PET/I | PET/I | PET/I | PET/I | PET/I | PET/I | PET/I |
| | Polymer component | | IPA | IPA | EG | CHDM | IPA | IPA | IPA | IPA | IPA | IPA | IPA | IPA | IPA |
| | Co-polymer [mol %] | | 17.5 | 9 | — | 5 | 17 | 15 | 12 | 12 | 8.5 | 8.5 | 8.5 | 8.5 | 8.5 |
| | IV | | 0.65 | 0.65 | 0.65 | 0.66 | 0.65 | 0.65 | 0.65 | 0.65 | 0.65 | 0.65 | 0.65 | 0.65 | 0.65 |
| | Particles.1 | kinds | Silica | Silica | Silica | Silica | — | — | — | — | Silica | Silica | Silica | Silica | Silica |
| | | D50 | 3.5 | 3.5 | 3.5 | 3.5 | — | — | — | — | 3.5 | 3.5 | 3.5 | 3.5 | 6 |
| | | Concentration (%) | 0.05 | 0.05 | 0.66 | 0.05 | — | — | — | — | 1.5 | 3 | 3 | 0.05 | 3 |
| | Particles 2 | kinds | — | TiO2 | TiO2 | — | TiO2 | TiO2 | TiO2 | TiO2 | — | — | — | — | — |
| | | D50 | — | 0.3 | 0.3 | — | 0.3 | 0.3 | 0.3 | 0.3 | — | — | — | — | — |
| | | Concentration (%) | — | 12 | 8 | — | 4 | 4 | 4 | 4 | — | — | — | — | — |
| | Additional material | | — | — | — | MXD6 | — | — | — | PBT(27%) | — | — | PBT(25%) | PBT(50%) | — |
| | | | | | | Polyamide | | | | | | | | | |
| | | | | | | 2.7 wt % | | | | | | | | | |
| | Melting temperature [° C.] | | 210 | 246 | 254 | 250 | 210 | 233 | 244 | 244 | 248 | 248 | 216/241 | 215/241 | 248 |
| | Thickness (um) | | 8 | 7.5 | 8 | 7.2 | 9 | 9 | 9 | 9 | 13.6 | 13.6 | 13.6 | 13.6 | 13.6 |
| | Ratio B layer/Total thickness (%) | | 66.7 | 62.5 | 66.7 | 60 | 75 | 75 | 75 | 75 | 80 | 80 | 80 | 80 | 80 |
| Polyester layer C | Formulation | | PET/I | PET/G | PET/G | PET/G | PET/I | PET/I | PET/I | PET/I | PET/I | PET/I | PET/I | PET/I | PET/I |
| | Polymer component | | IPA | CHDM | CHDM | CHDM | IPA | IPA | IPA | IPA | IPA | IPA | IPA | IPA | IPA |
| | Co-polymer [mol %] | | 17 | 28 | 28 | 22 | 17 | 15 | 12 | 12 | 8.5 | 8.5 | 8.5 | 8.5 | 8.5 |
| | IV | | 0.65 | 0.75 | 0.75 | 0.75 | 0.65 | 0.65 | 0.65 | 0.65 | 0.65 | 0.65 | 0.65 | 0.65 | 0.65 |
| | Particles | kinds | Silica | Silica | — | — | Silica | — | — | — | Silica | Silica | Silica | Silica | Silica |
| | | D50 | 3.5 | 2.5 | — | — | 2.5 | — | — | — | 3.5 | 3.5 | 3.5 | 3.5 | 3.5 |
| | | Concentration (%) | 0.05 | 0.3 | — | — | 0.2 | — | — | — | 3 | 3 | 3 | 3 | 3 |

| | | | | | | | | | | | | | | |
|---|---|---|---|---|---|---|---|---|---|---|---|---|---|---|
| | Additional material | — | — | — | — | — | — | — | — | — | — | — | — | — |
| | Melting temperature [° C.] | 210 | — | — | — | 210 | 233 | 244 | 244 | 248 | 248 | 248 | 248 | 248 |
| | Thickness (um) | 2.5 | 2.5 | 2.5 | 2.4 | 1.5 | 1.5 | 1.5 | 1.5 | 1.7 | 1.7 | 1.7 | 1.7 | 1.7 |
| | Ratio C layer/Total thickness (%) | 20.8 | 20.8 | 20.8 | 20 | 21 | 21 | 21 | 21 | 10 | 10 | 10 | 10 | 10 |
| Film | Total thickness (um) | 12 | 12 | 12 | 12 | 12 | 12 | 12 | 12 | 17 | 17 | 17 | 17 | 17 |
| | IV | 0.63 | 0.66 | 0.65 | 0.59 | 0.58 | 0.59 | 0.6 | 0.58 | 0.58 | 0.55 | 0.57 | 0.56 | 0.56 |
| | TLT(%) | 62 | 60.9 | 61.5 | 60.8 | 83.6 | 85.7 | 79.2 | 59.2 | 86.2 | 69.6 | 70.2 | 67.4 | 68.5 |
| | Haze(%) | 97.3 | 98.6 | 96.1 | 97.9 | 70.2 | 67.8 | 58.9 | 99.5 | 75.2 | 83.5 | 85.1 | 90.6 | 93.1 |
| Al Lamination | Lamination Temperature - T1 ° C. | 230 | 200 | 200 | 200 | 200 | 200 | 200 | 200 | — | — | 240 | 240 | — |
| result | Annealing temp T2 ° C. | 265 | 265 | 280 | 280 | 265 | 265 | 265 | 265 | — | — | 265 | 265 | — |
| | Alum. Rp 0.2 [Mpa} | 346 | 353 | 325 | 328 | 340 | 341 | 340 | 342 | — | — | 313 | 325 | — |
| | Before pasteurization at 80° C. for 40 min-max. feathering | 0.6 | 1.4 | 0.9 | 1.2 | 0.7 | 1.1 | 1.1 | 1.1 | — | — | 0.7 | 0.8 | — |
| | [mm] | | | | | | | | | | | | | |
| | Before Pasteurization - Cross cut adhesion | 1.5 | 1 | 1 | 1 | 2 | 2 | 2 | 2 | — | — | 1 | 1 | — |
| | After pasteurization at 80° C. for 40 min-max feathering | 3.2 | 3.2 | 0.9 | 1.1 | 1.1 | 1.2 | 1.1 | 0.9 | — | — | 1.1 | 1.1 | — |
| | [mm] | | | | | | | | | | | | | |
| | After Pasteurization - Cross cut adhesion2 | 4 | 2 | 1 | 1 | 2 | 2 | 3 | 1 | — | — | 1 | 2 | — |
| | After Pasteurization - Blushing | 10 | 10 | 10 | 7 | 8 | 9 | 9 | 8 | — | — | 9 | 8 | — |
| | Cross cut after 3% acetic acid 30 min 100° C. | 5 | 1 | 1 | 1 | 4 | 2 | 1 | 4 | — | — | 1 | 1 | — |
| | Cross cut before 3% acetic acid 30 min 100° C. | delami. | No | No | No | delami | No | No | No | — | — | No | No | — |
| | | | delami | delami | delami | | delami | delami | delami | | | delami | delami | |
| | Blushing after 3% acetic acid 30 min 100° C. | 3 | 10 | 9 | 4 | 3 | 3 | 3 | 3 | — | — | 5 | 5 | — |
| | Cross cut after Citric acid retort 30 min 121° C. | 5 | 1 | 1 | 3 | 2 | 3 | 4 | 4 | — | — | 4 | 4 | — |
| | Cross cut before Citric acid retort 30 min 121° C. | delami. | No | No | No | delami. | delami | delami | delami | — | — | delami | delami | — |
| | | | delami | delami | delami | | | | | | | | | |
| | Blushing after Citric acid retort 30 min 121° C. | 7 | 8 | 10 | 5 | 7 | 7 | 7 | 7 | — | — | 7 | 7 | — |
| | Tensile Test: Microscopy: cracks in the film | OK | OK | OK | OK | OK | OK | OK | OK | — | — | OK | OK | — |

1. A laminate “aluminium/multilayer biaxially oriented polyester film” for the manufacturing of beverage can ends comprising successively:
M—an aluminum support;
C—at least one amorphous layer C comprising at least one copolyester PET-G—which the diol units include Ethylene Glycol EG—units and CycloHexaneDiMethanol CHDM—units;
B—at least one polyester layer B comprising:
at least one copolyester PET-I which the diol units include Ethylene Glycol EG—units and which the acid units include Terephtalic Acid TA—units and Isophtalic Acid IA—units;
and
possibly at least one polyester PolyEthyleneTerephtalate PET;
A—at least one layer A, identical or different from the layer B and comprising at least one polyester, and possibly at least one copolyester PET-I which the diol units include Ethylene Glycol EG—units and which the acid units include Terephtalic Acid TA—units and Isophtalic Acid IA—units;
wherein
i the concentration of the CHDM units in the layer C is comprised between 18 and 34 mol %.
ii the concentration of the IA units in the layer B is greater than or equal to 9 mol %.
iii at least one of the layers C,BA, incorporates filler particles which have a median diameter d50 in the following ranges given herein in an increasing order of preference and in μm: [2.0-12.0], [3.0-10], [5.0-9.0].

2. A laminate according to claim 1 wherein the layer B and/or the layer A comprises:
at least one copolyester PBT-I which the diol units include Butylene Glycol BG—units and which the acid units include Terephtalic Acid TA—units and Isophtalic Acid IA—units;
and
possibly at least one polyester PolyButyleneTerephtalate PBT.

3. A laminate according to claim 1 wherein the layer A is different from the layer B, wherein the layer A is crystallizable layer of polyester resin including at least 50% by weight of Poly-Ethylene Terephthalate (PET).

4. A laminate according to claim 1 wherein at least one of the layers C,B,A, includes fine particles different from the filler particles.

5. A laminate according to claim 4 wherein the fine particles and the filler particles are chosen among inorganic and/or organic particles, in the group comprising and in the group consisting in: titanium oxide, barium sulfate, silicon dioxide, aluminum oxide particles, zirconium oxide, tin oxide, calcium carbonate, calcium phosphate, zeolite, hydroxyapatite, aluminum silicate, wet-based and dry-based colloidal silica and alumina, polymer including styrene, silicone, polyacrylic acid, polymethacrylic acid, polyester, polymer including divinyl benzene and mixtures thereof.

6. A laminate according to claim 5 wherein the fine particles comprise barium sulfate and/or titanium oxide particles, in the following concentration ranges given herein in an increasing order of preference and in % w/w: [1-25]; [2-20]; [3-10].

7. A laminate according to claim 5 wherein the filler particles include silicon dioxide particles.

8. A laminate according to claim 1, wherein the intrinsic viscosity (IV) of any layer is between 0.45 to 0.70 dl/g.

9. A laminate according to claim 1, wherein the C-layer thickness is comprised within the following ranges given herein in an increasing order of preference and in μm: [0.3-6.0]; [0.5-5.0]; [0.7-4.0].

10. A laminate according to claim 1, wherein the C-layer thickness is comprised within the following ranges given herein in an increasing order of preference and in % of the overall film thickness: [0.5-40]; [0.8-25]; [1.0-20].

11. A laminate according to claim 1, which:
1st—the total light transmittance, TLT measured on the film is comprised between the following ranges given herein in an increasing order of preference and in %:[<90]; [<80]; [<70]; and/or
2nd—the Haze measured on the film is comprised between following ranges given herein in an increasing order of preference and in %: [>70];
[>80]; [>90].

12. A laminate according to claim 1, which the decrease of the feathering after lamination with aluminium substrates between the following ranges given herein in an increasing order of preference and in mm: [<0.8]; [<0.7];
[<0.6].

13. A method for manufacturing a laminate according to claim 1, wherein the multilayer biaxially oriented polyester film is laminated with a aluminium support, said lamination comprising a preheating step of the aluminium from 180 to 220° C., a lamination step, an annealing step in the range of 250° C. to 275° C. and cooling step.

14. An easy-open end for beverage can made from the laminate according to claim 1 or obtained from method for manufacturing the laminate, wherein the multilayer biaxially oriented polyester film is laminated with a aluminium support, said lamination comprising a preheating step of the aluminium from 180 to 220° C., a lamination step, an annealing step in the range of 250° C. to 275° C. and cooling step, and wherein the multilayer biaxially oriented polyester film is the internal wall of said can end and is in contact with the beverage.
